(19) United States
(12) Patent Application Publication
(10) Pub. No.: US 2011/0068847 A1
(43) Pub. Date: Mar. 24, 2011

(54) EQUALIZER CIRCUIT AND RECEPTION APPARATUS

(75) Inventors: Takayuki HAMADA, Kawasaki (JP); Hirotaka Tamura, Kawasaki (JP)

(73) Assignee: FUJITSU LIMITED, Kawasaki (JP)

(21) Appl. No.: 12/876,880

(22) Filed: Sep. 7, 2010

(30) Foreign Application Priority Data
Sep. 18, 2009 (JP) 2009-217409

(51) Int. Cl. G06G 7/19

(52) U.S. Cl. 327/336

(57) ABSTRACT

An equalizer circuit includes: a plurality of amplifiers that convert a voltage signal into a current; a plurality of capacitive loads that are charged and discharged in accordance with respective outputs of the plurality of amplifiers; a charge discharge circuit provided for each of the plurality of capacitive loads to charge or discharge one of the plurality of capacitive loads; and a reset circuit provided for each of the capacitive loads to initialize the charge stored in the one of the plurality of capacitive loads, wherein a current according to the voltage signal is integrated in different periods for each of the plurality of capacitive loads and the capacitive load is discharged through the current in a first period and the capacitive load is charged through the current in a second period following the first period.

### CROSS-REFERENCE TO RELATED APPLICATIONS

This application claims the benefit of priority from Japanese Patent Application No. 2009-217409 filed on Sep. 18, 2009, the entire contents of which are incorporated herein by reference.

### BACKGROUND

1. Field

The embodiments discussed herein relate to an equalizer circuit and a reception apparatus having the equalizer circuit.

2. Description of Related Art

An equalizer circuit that compensates for the frequency characteristics of channels may be used in signal transmission at data rates from several Gbps to several tens of Gbps. For example, a transmission path (channel) may have the characteristics of a low-pass filter, and therefore a signal at a high frequency may be attenuated by the transmission path.

A related art is disclosed, for example, in Willy M. C. Sansen, “Analog Design Essentials”, Springer.

### SUMMARY

According to one aspect of the embodiments, an equalizer circuit is provided which includes a plurality of amplifiers that convert a voltage signal into a current; a plurality of capacitive loads that are charged and discharged in accordance with respective outputs of the plurality of amplifiers; a charge and discharge circuit provided for each of the plurality of capacitive loads to charge and discharge one of the plurality of capacitive loads; and a reset circuit provided for each of the capacitive loads to initialize the charge stored in the one of the plurality of capacitive loads, wherein a current according to the voltage signal is integrated in different periods for each of the plurality of capacitive loads and the capacitive load is discharged through the current in a first period and the capacitive load is charged through the current in a second period following the first period.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

FIG. 1 illustrates an exemplary analog high-pass filter;

FIG. 2 illustrates an exemplary equalizer circuit;

FIG. 3 illustrates an exemplary operation of an equalizer circuit;

FIG. 4 illustrates an exemplary operation of an equalizer circuit;

FIG. 5A illustrates an exemplary multi-phase timing signal generation circuit;

FIG. 5B illustrates an exemplary output of a voltage control oscillator (VCO);

FIG. 5C illustrates an exemplary output of logical product computation circuits;

FIG. 6 illustrates an exemplary equalizer circuit;

FIGS. 7A and 7B illustrate an exemplary equalizer circuit;

FIG. 8 illustrates an exemplary equalizer circuit;

FIG. 9 illustrates an exemplary equalizer circuit;

FIGS. 10A and 10B illustrate an exemplary equalizer circuit;

FIG. 11 illustrates an exemplary equalizer circuit; and

FIG. 12 illustrates an exemplary receiver.

### DESCRIPTION OF EMBODIMENTS

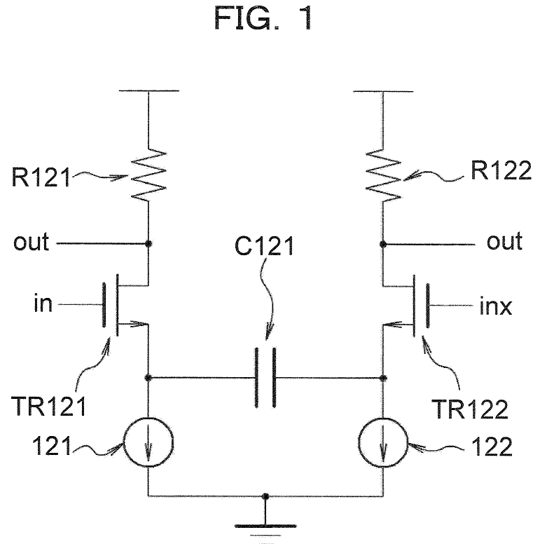

FIG. 1 illustrates an exemplary analog high-pass filter. The high-pass filter receives differential input signals in and inx, and outputs differential output signals out and outx. In an N-channel MOS (metal oxide semiconductor) transistor TR121, the gate receives the input signal in, the source is coupled to a current source 121, and the drain is coupled to a power source voltage via a resistance R121. In an N-channel MOS transistor TR122, the gate receives the input signal inx, the source is coupled to a current source 122, and the drain is coupled to a power source voltage via a resistance R122. The respective sources of the N-channel MOS transistors TR121 and TR122 are coupled to a capacitance C121. The output signal out is output from a connection point between the drain of the N-channel MOS transistor TR121 and the resistance R121 to a output signal line. The output signal outx is output from a connection point between the drain of the N-channel MOS transistor TR122 and the resistance R122.

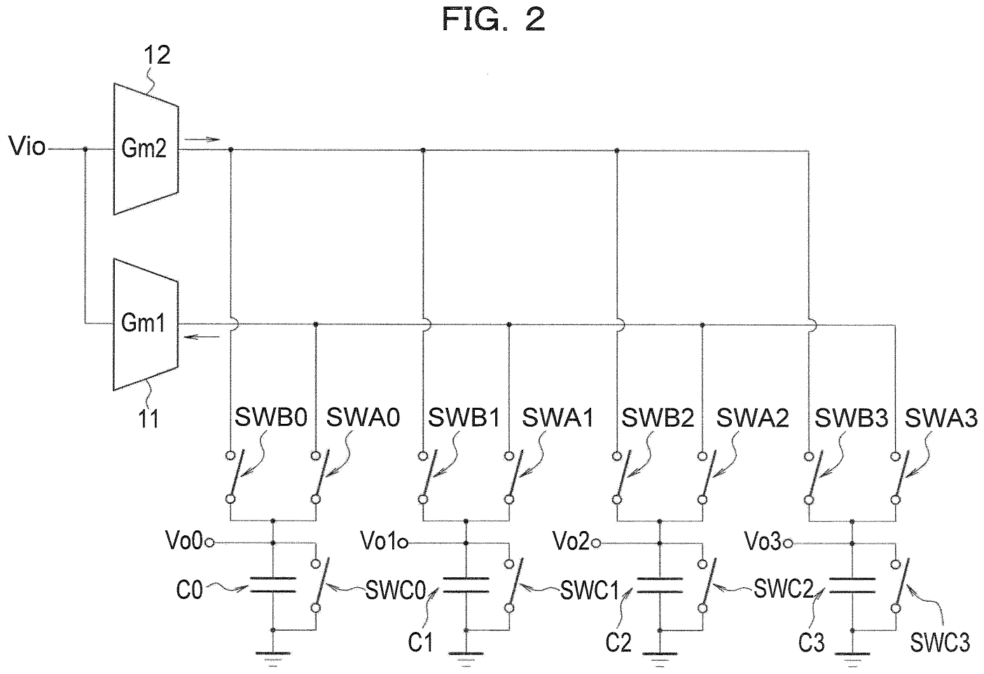

FIG. 2 illustrates an exemplary equalizer circuit. Reference numerals 11 and 12 each denote a transconductor (amplifier) that converts a voltage signal into a current. Cj denotes a capacitive load that is charged and discharged in accordance with respective outputs of the transconductors 11 and 12. SWAj, SWBj, and SWCj each denote a switch. The letter “j” is a suffix, and the value of “j” may be any of 0, 1, 2, and 3, for example.

The transconductors 11 and 12 receive a voltage signal via an input terminal Vi, and outputs a current according to the voltage signal. The transconductance Gm1 of the transconductor 11 may be negative. The transconductance Gm2 of the transconductor 12 may be positive. When a signal input from the input terminal Vi has a voltage V, the transconductor 11 outputs a current that flows in the direction of the illustrated arrow (Gm1×V), and the transconductor 12 outputs a current that flows in the direction of the illustrated arrow (Gm2×V).

One end of the capacitive load C0 is coupled to the transconductor 11 via the switch SWA0, to the transconductor 12 via the switch SWB0, and to a reference potential, for example a ground, via the switch SWC0. The other end of the capacitive load C0 is coupled to the reference potential. The one end of the capacitive load C0 is coupled to an output terminal Vo0.

One end of the capacitive load C1 is coupled to the transconductor 11 via the switch SWA1, to the transconductor 12 via the switch SWB1, and to the reference potential via the switch SWC1. The other end of the capacitive load C1 is coupled to the reference potential. The one end of the capacitive load C1 is coupled to an output terminal Vo1.

One end of the capacitive load C2 is coupled to the transconductor 11 via the switch SWA2, to the transconductor 12 via the switch SWB2, and to the reference potential via the switch SWC2. The other end of the capacitive load C2 is coupled to the reference potential. The one end of the capacitive load C2 is coupled to an output terminal Vo2.

One end of the capacitive load C3 is coupled to the transconductor 11 via the switch SWA3, to the transconductor 12 via the switch SWB3, and to the reference potential via the switch SWC3. The other end of the capacitive load C3 is coupled to the reference potential. The one end of the capacitive load C3 is coupled to an output terminal Vo3.

The output terminals Vo0, Vo1, Vo2, and Vo3 may be electrically coupled to respective input terminals of a plurality of A/D converters (not illustrated) that operate in a time-interleaving manner.

The equalizer circuit illustrated in FIG. 2 includes a unit circuit, for example an integrate-and-dump sampler, that includes the transconductors 11 and 12 and the capacitive load Cj and the switches SWAj, SWBj, and SWCj with the suffix j having the same value. The switches SWAj, SWBj, and SWCj are controlled such that a current according to the voltage signal input from the input terminal Vi is integrated in different periods for each unit circuit. The equalizer circuit performs a high-pass filtering process.

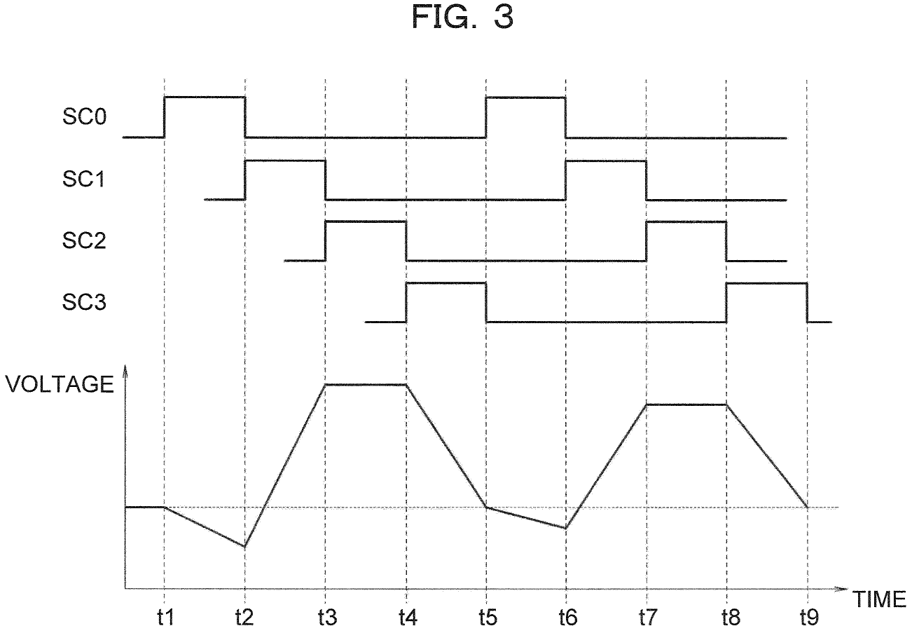

FIG. 3 illustrates an exemplary operation of the equalizer circuit. The switch SWA0 is controlled by a control signal SC0. The switch SWB0 is controlled by a control signal SC1. The switch SWC0 is controlled by a control signal SC3. Each of the switches SWA0, SWB0, and SWC0 is turned on, for example become a conductive state, when the control signal is at a high level, and is turned off, for example become a non-conductive state, when the control signal is at a low level. FIG. 3 illustrates exemplary control signals SC0, SC1, SC2, and SC3 and a voltage of the capacitive load C0.

When the control signal SC0 is at a high level, the switch SWA0 is turned on to couple the transconductor 11 and the capacitive load C0. Therefore, the capacitive load C0 is discharged through a current (charge) according to the voltage signal input from the input terminal Vi. When the control signal SC1 is at a high level, the switch SWB0 is turned on to couple the transconductor 12 and the capacitive load C0. Therefore, the capacitive load C0 is charged based on a current (charge) according to the voltage signal input from the input terminal Vi. When the control signal SC2 is at a high level, all of the switches SWA0, SWB0, and SWC0 are turned off. Thus, the charge stored in the capacitive load C0 is held. When the control signal SC3 is at a high level, the switch SWC0 is turned on to couple the ends of the capacitive load C0 to the reference potential. Therefore, the charge stored in the capacitive load C0 is discharged to be reset, for example initialized.

In time periods from t1 to t2 and from t5 to t6 when the control signal SC0 is at a high level, the capacitive load C0 is discharged through a current (charge) according to the input signal. In time periods from t2 to t3 and from t6 to t7 when the control signal SC1 is at a high level, the capacitive load C0 is charged through a current (charge) according to the input signal. In time periods from t3 to t4 and from t7 to t8 when the control signal SC2 is at a high level, the current (charge) stored in the capacitive load C0 is held. In time periods from t4 to t5 and from t8 to t9 when the control signal SC3 is at a high level, the load stored in the capacitive load C0 is reset.

Each unit circuit of the equalizer circuit repeatedly discharges the capacitive load Cj through a current (charge) according to the input signal or charges the capacitive load Cj through a current (charge) according to the input signal into the capacitive load Cj, holds the charge stored in the capacitive load Cj, and resets the capacitive load Cj. Discharging the capacitive load Cj through a current (charge) according to the input signal in a certain period, for example a sampling period, and charging the capacitive load Cj through a current (charge) according to the input signal in the next sampling period may correspond to an operation of a digital high-pass filter. In a period in which the stored charge is held during the operation corresponding to the high-pass filter, the voltage of the capacitive load Cj is supplied to the A/D converter via the output terminal Voj. When a high-pass filtering process is performed digitally, the intensity of high-frequency components of the signal is recovered, and the gain is supplied. The equalizer circuit generates an equalized signal subjected to an equalization process by compensating for high-frequency components attenuated through signal transmission without being affected by variations in element characteristics.

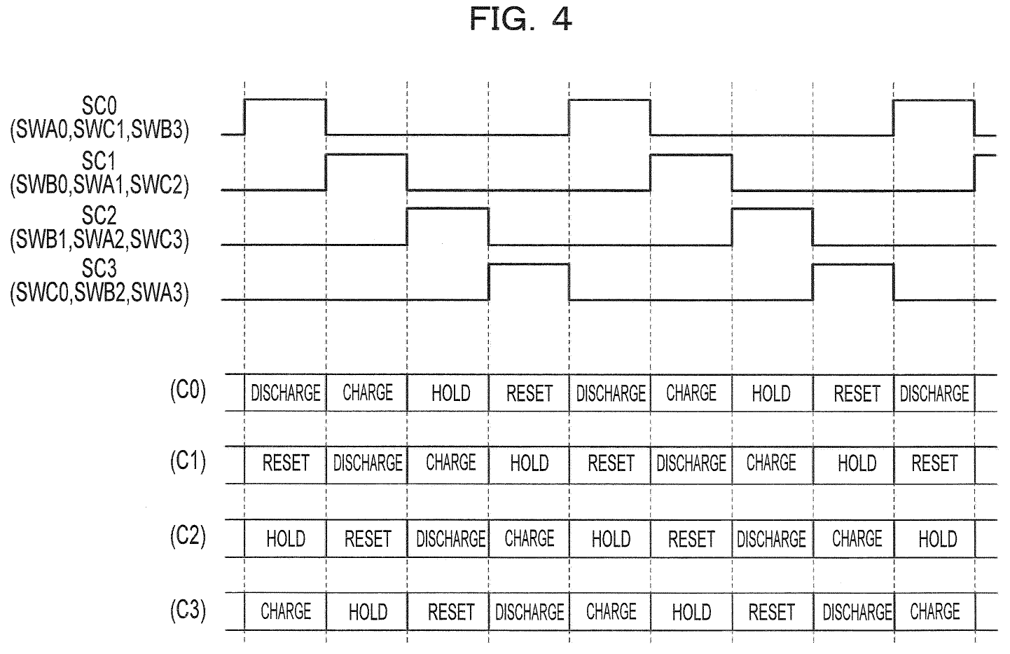

FIG. 4 illustrates an exemplary operation of an equalizer circuit. In FIG. 4, the switches SWA0, SWC1, and SWB3 are controlled by the control signal SC0. The switches SWB0, SWA1, and SWC2 are controlled by the control signal SC1. The switches SWB1, SWA2, and SWC3 are controlled by the control signal SC2. The switches SWC0, SWB2, and SWA3 are controlled by the control signal SC3. Each of the switches SWAj, SWBj, and SWCj is turned on, for example become a conductive state, when the control signal is at a high level, and is turned off, for example become a non-conductive state, when the control signal is at a low level.

Each of the switches SWAj, SWBj, and SWCj is controlled by the control signal SC0, SC1, SC2, or SC3. Therefore, in the capacitive load Cj in each unit circuit, the capacitive load Cj is discharged through a current (charge) according to the input signal, the capacitive load Cj is charged through a current (charge) according to the input signal, the stored charge is held, and the stored charge is reset repeatedly. A current (charge) according to the input signal is released, a current (charge) according to the input signal is injected, the stored charge is held, and the stored charge is reset in periods shifted for each unit circuit. By integrating a current according to the input signal from the input terminal Vi in different periods for each unit circuit, the equalizer circuit performs a digital high-pass filtering process.

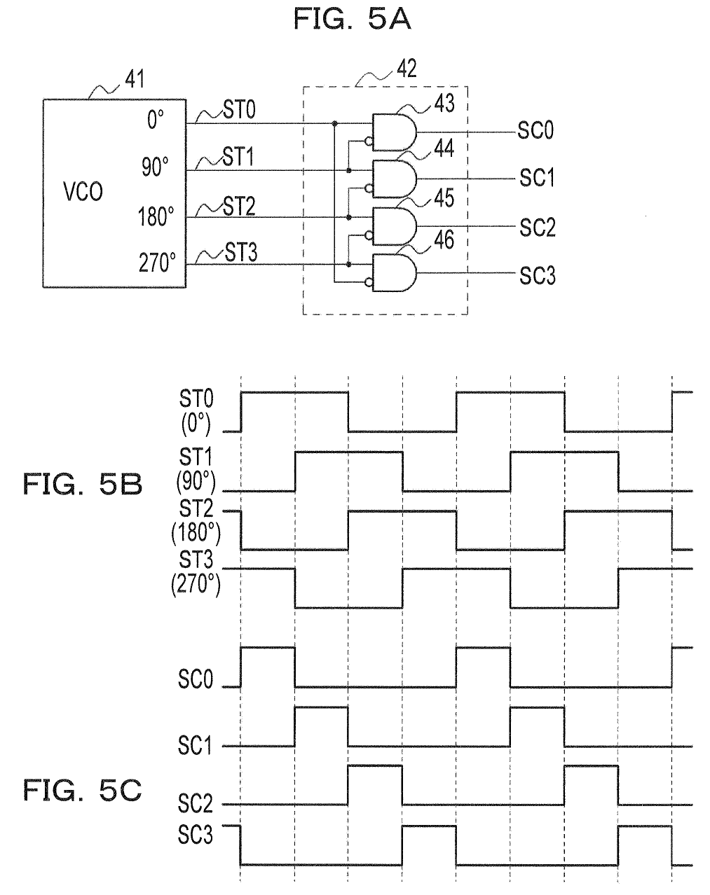

FIG. 5A illustrates an exemplary multi-phase timing signal generation circuit. The multi-phase timing signal generation circuit generates the control signals SC0, SC1, SC2, and SC3. Reference numeral 41 denotes a voltage control oscillator (VCO) that outputs 4-phase clock signals (oscillation signals) ST0, ST1, ST2, and ST3. FIG. 5B illustrates an exemplary output of a voltage control oscillator (VCO). The voltage control oscillator (VCO) 41 illustrated in FIG. 5A outputs the 4-phase clock signals ST0, ST1, ST2, and ST3, the respective phases of which are shifted by 90 degrees, for example 0°, 90°, 180°, and 270°.

Reference numeral 42 denotes a signal generation circuit that generates the control signals SC0, SC1, SC2, and SC3 based on the 4-phase clock signals ST0, ST1, ST2, and ST3. The signal generation circuit 42 includes logical product computation circuits (AND circuits) 43, 44, 45, and 46. The AND circuit 43 receives the clock signal (0°) ST0 as an input and the clock signal (90°) ST1 as an inverted input, and outputs the computation results as the control signal SC0. The AND circuit 44 receives the clock signal (90°) ST1 as an input and the clock signal (180°) ST2 as an inverted input, and outputs the computation results as the control signal SC1. The AND circuit 45 receives the clock signal (180°) ST2 as an input and the clock signal (270°) ST3 as an inverted input, and outputs the computation results as the control signal SC2. The AND circuit 46 receives the clock signal (270°) ST3 as an input and the clock signal (0°) ST0 as an inverted input, and outputs the computation results as the control signal SC3.

FIG. 5C illustrates an exemplary output of a logical product computation circuits. The generated control signals SC0, SC1, SC2, and SC3 may be activated in periods different from each other. The generated control signals may be activated exclusively. When the clock signal ST0 is at a high level and the clock signal ST1 is at a low level, the high-level control signal SC0 is output. In the other periods, the low-level control signal SC0 is output. When the clock signal ST1 is at a high level and the clock signal ST2 is at a low level, the high-level control signal SC1 is output. In the other periods, the low-level control signal SC1 is output. When the clock signal ST2 is at a high level and the clock signal ST3 is at a low level, the high-level control signal SC2 is output. In the other periods, the low-level control signal SC2 is output. When the clock signal ST3 is at a high level and the clock signal ST0 is at a low level, the high-level control signal SC3 is output. In the other periods, the low-level control signal SC3 is output.

An N-channel MOS transistor may be referred to as an “NMOS transistor”. A P-channel MOS transistor may be referred to as a “PMOS transistor”. The control signals SC0, SC1, SC2, and SC3 may correspond to the signals illustrated in FIG. 5C.

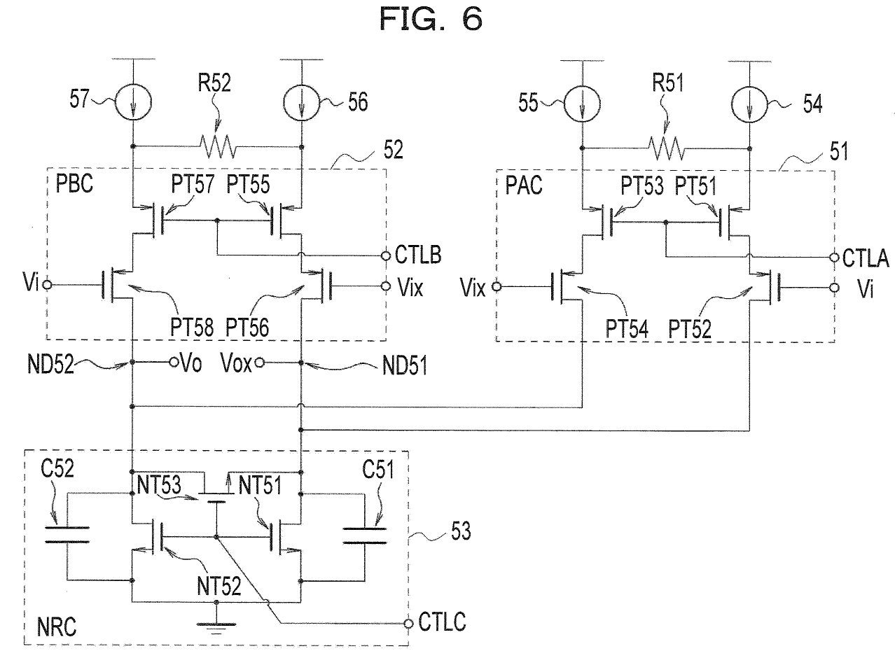

FIG. 6 illustrates an exemplary equalizer circuit. The equalizer circuit illustrated in FIG. 6 may correspond to a unit circuit.

Reference numeral 51 denotes a first circuit (PAC) that releases a current (charge) according to an input voltage signal. Reference numeral 52 denotes a second circuit (PBC) that injects a current (charge) according to an input voltage signal. Reference numeral 53 denotes a reset circuit (NRC) that resets a capacitive load.

The first circuit (PAC) 51 includes PMOS transistors PT51, PT52, PT53, and PT54. The gate of the PMOS transistor PT51 is coupled to an input terminal CTLA. The source of the PMOS transistor PT51 is coupled to a current source 54. The drain of the PMOS transistor PT51 is coupled to the source of the PMOS transistor PT52. The gate of the PMOS transistor PT52 is coupled to an input terminal Vi. The drain of the PMOS transistor PT52 is coupled to a node ND51. The gate of the PMOS transistor PT53 is coupled to the input terminal CTLA. The source of the PMOS transistor PT53 is coupled to a current source 55. The drain of the PMOS transistor PT53 is coupled to the source of the PMOS transistor PT54. The gate of the PMOS transistor PT54 is coupled to an input terminal Vix. The drain of the PMOS transistor PT54 is coupled to a node ND52. A resistance R51 is coupled between the respective sources of the PMOS transistors PT51 and PT53.

The second circuit (PBC) 52 includes PMOS transistors PT55, PT56, PT57, and PT58. The gate of the PMOS transistor PT55 is coupled to an input terminal CTLB. The source of the PMOS transistor PT55 is coupled to a current source 56. The drain of the PMOS transistor PT55 is coupled to the source of the PMOS transistor PT56. The gate of the PMOS transistor PT56 is coupled to an input terminal Vix. The drain of the PMOS transistor PT56 is coupled to the node ND51. The gate of the PMOS transistor PT57 is coupled to the input terminal CTLB. The source of the PMOS transistor PT57 is coupled to a current source 57. The drain of the PMOS transistor PT57 is coupled to the source of the PMOS transistor PT58. The gate of the PMOS transistor PT58 is coupled to an input terminal Vi. The drain of the PMOS transistor PT58 is coupled to the node ND52. A resistance R52 is coupled between the respective sources of the PMOS transistors PT55 and PT57.

The reset circuit (NRC) 53 includes capacitive loads C51 and C52 and NMOS transistors NT51, NT52, and NT53. One end of the capacitive load C51 is coupled to the node ND51. The other end of the capacitive load C51 is coupled to a reference potential, for example a ground. One end of the capacitive load C52 is coupled to the node ND52. The other end of the capacitive load C52 is coupled to the reference potential. The gate of the NMOS transistor NT51 is coupled to an input terminal CTLC. The source of the NMOS transistor NT51 is coupled to the reference potential. The drain of the NMOS transistor NT51 is coupled to the one end of the capacitive load C51. The gate of the NMOS transistor NT52 is coupled to the input terminal CTLC. The source of the NMOS transistor NT52 is coupled to the reference potential. The drain of the NMOS transistor NT52 is coupled to the one end of the capacitive load C52. The gate of the NMOS transistor NT53 is coupled to the input terminal CTLC. The source of the NMOS transistor NT53 is coupled to the one end of the capacitive load C51. The drain of the NMOS transistor NT53 is coupled to the one end of the capacitive load C52.

An output terminal Vo is coupled to the node ND52. An output terminal Vox is coupled to the node ND51.

Any of the control signals SC0, SC1, SC2, and SC3 is input to the input terminal CTLA of the first circuit (PAC), the input terminal CTLB of the second circuit (PBC), and the input terminal CTLC of the reset circuit (NRC). The control signals input to the input terminals CTLA, CTLB, and CTLC may be different from each other. For example, when the control signal SC0 is input to the input terminal CTLA, the control signal SC1 may be input to the input terminal CTLB, and the control signal SC3 may be input to the input terminal CTLC. A differential input signal input to the equalizer circuit, for example an in-phase signal Vi, may be input to the input terminal Vi of the first circuit (PAC) and the input terminal Vi of the second circuit (PBC). A differential input signal input to the equalizer circuit, for example an opposite-phase signal Vix, may be input to the input terminal Vix of the first circuit (PAC) and the input terminal Vix of the second circuit (PBC).

A circuit including the PMOS transistors PT52 and PT54, the current sources 54 and 55, and the resistance R51 may correspond to the transconductor 11 illustrated in FIG. 2. A circuit including the PMOS transistors PT51 and PT53 may correspond to the switch SWAj illustrated in FIG. 2. A circuit including the PMOS transistors PT56 and PT58, the current sources 56 and 57, and the resistance R52 may correspond to the transconductor 12 illustrated in FIG. 2. A circuit including the PMOS transistors PT55 and PT57 may correspond to the switch SWBj illustrated in FIG. 2. A circuit including the NMOS transistors NT51, NT52, and NT53 may correspond to the switch SWCj illustrated in FIG. 2. The capacitive loads C51 and C52 may correspond to the capacitive load Cj illustrated in FIG. 2. The first circuit (PAC) 51 charges the capacitive loads C51 and C52 through a current (charge) according to input signals Vix and Vi, which are in opposite phase to input signals Vi and Vix which the second circuit (OBC) 52 uses for charging loads C51 and C52. Since the capacitive loads C51 and C52 is charged through a current (charge) according to the input signals Vix and Vi in the opposite phase, the first circuit (PAC) 51 discharges the capacitive loads C51 and C52 through a current (charge) according to the input signals Vix and Vi from the capacitive loads C51 and C52.

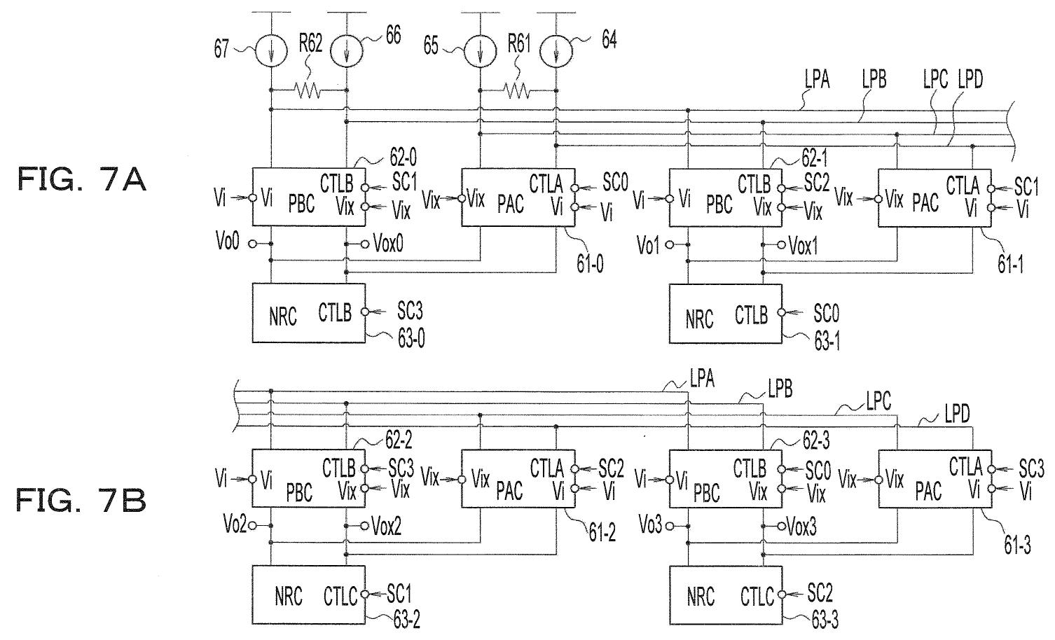

FIGS. 7A and 7B illustrate an exemplary equalizer circuit. Reference numerals 61-0, 61-1, 61-2, and 61-3 each denote a first circuit (PAC) that discharges a capacitive load through a current (charge) according to an input signal. The first circuits (PAC) illustrated in FIGS. 7A and 7B may be substantially the same as or similar to the first circuit (PAC) 51 illustrated in FIG. 6. Reference numerals 62-0, 62-1, 62-2, and 62-3 each denote a second circuit (PBC) that charges a capacitive load through a current (charge) according to an input signal. The second circuits (PBC) illustrated in FIGS. 7A and 7B may be substantially the same as or similar to the second circuit (PBC) 52 illustrated in FIG. 6. Reference numerals 63-0, 63-1, 63-2, and 63-3 each denote a reset circuit (NRC) that resets a charge in a capacitive load. The reset circuits (NRC) illustrated in FIGS. 7A and 7B may be substantially the same as or similar to the reset circuit (NRC) 53 illustrated in FIG. 6.

The differential input signal Vi input to the equalizer circuit is input to the input terminal Vi of each of the first circuits (PAC) 61-0, 61-1, 61-2, and 61-3 and the second circuits (PBC) 62-0, 62-1, 62-2, and 62-3. The differential input signal Vix input to the equalizer circuit is input to the input terminal Vix of each of the first circuits (PAC) 61-0, 61-1, 61-2, and 61-3 and the second circuits (PBC) 62-0, 62-1, 62-2, and 62-3.

A unit circuit includes the first circuit (PAC) 61-0, the second circuit (PBC) 62-0, the reset circuit (NRC) 63-0, current sources 64, 65, 66, and 67, and resistances R61 and R62, and outputs output signals Vo0 and Vox0. The control signal SC0 is input to the input terminal CTLA of the first circuit (PAC) 61-0. The control signal SC1 is input to the input terminal CTLB of the second circuit (PBC) 62-0. The control signal SC3 is input to the input terminal CTLC of the reset circuit (NRC) 63-0.

A unit circuit includes the first circuit (PAC) 61-1, the second circuit (PBC) 62-1, the reset circuit (NRC) 63-1, the current sources 64, 65, 66, and 67, and the resistances R61 and R62, and outputs output signals Vo1 and Vox1. The control signal SC1 is input to the input terminal CTLA of the first circuit (PAC) 61-1. The control signal SC2 is input to the input terminal CTLB of the second circuit (PBC) 62-1. The control signal SC0 is input to the input terminal CTLC of the reset circuit (NRC) 63-1.

A unit circuit includes the first circuit (PAC) 61-2, the second circuit (PBC) 62-2, the reset circuit (NRC) 63-2, the current sources 64, 65, 66, and 67, and the resistances R61 and R62, and outputs output signals Vo2 and Vox2. The control signal SC2 is input to the input terminal CTLA of the first circuit (PAC) 61-2. The control signal SC3 is input to the input terminal CTLB of the second circuit (PBC) 62-2. The control signal SC1 is input to the input terminal CTLC of the reset circuit (NRC) 63-2.

A unit circuit includes the first circuit (PAC) 61-3, the second circuit (PBC) 62-3, the reset circuit (NRC) 63-3, the current sources 64, 65, 66, and 67, and the resistances R61 and R62, and outputs output signals Vo3 and Vox3. The control signal SC3 is input to the input terminal CTLA of the first circuit (PAC) 61-3. The control signal SC0 is input to the input terminal CTLB of the second circuit (PBC) 62-3. The control signal SC2 is input to the input terminal CTLC of the reset circuit (NRC) 63-3.

The equalizer circuit performs an equalization operation illustrated for example in FIG. 4 based on the control signals SC0, SC1, SC2, and SC3 generated by a multi-phase timing signal generation circuit.

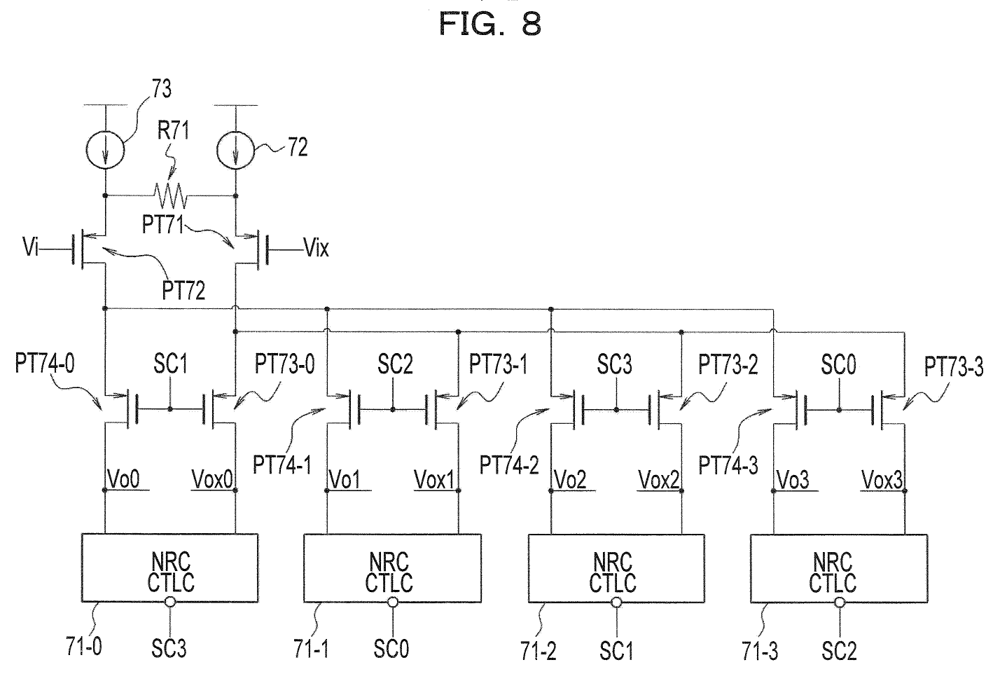

FIG. 8 illustrates an exemplary equalizer circuit. In FIG. 8, a circuit that discharges a capacitive load through a current (charge) according to an input voltage signal from a capacitive load.

Reference numerals 71-0, 71-1, 71-2, and 71-3 each denote a reset circuit (NRC) that resets a charge in a capacitive load, which may be substantially the same as or similar to the reset circuit (NRC) 53 illustrated in FIG. 6. The control signal SC3 is input to the input terminal CTLC of the reset circuit (NRC) 71-0. The control signal SC0 is input to the input terminal CTLC of the reset circuit (NRC) 71-1. The control signal SC1 is input to the input terminal CTLC of the reset circuit (NRC) 71-2. The control signal SC2 is input to the input terminal CTLC of the reset circuit (NRC) 71-3.

The differential input signal Vix is input to the gate of the PMOS transistor PT71. The source of the PMOS transistor PT71 is coupled to a current source 72. The differential input signal Vi is input to the gate of the PMOS transistor PT72. The source of the PMOS transistor PT72 is coupled to a current source 73. A resistance R71 is coupled between the respective sources of the PMOS transistors PT71 and PT72.

The control signal SC1 is input to the gate of the PMOS transistor PT73-0. The source of the PMOS transistor PT73-0 is coupled to the drain of the PMOS transistor PT71. The drain of the PMOS transistor PT73-0 is coupled to a signal line for the output signal Vox0. The control signal SC1 is input to the gate of the PMOS transistor PT74-0. The source of the PMOS transistor PT74-0 is coupled to the drain of the PMOS transistor PT72. The drain of the PMOS transistor PT74-0 is coupled to a signal line for the output signal Vo0.

The control signal SC2 is input to the gate of the PMOS transistor PT73-1 (PT74-4). The source of the PMOS transistor PT73-1 (PT74-1) is coupled to the drain of the PMOS transistor PT71 (PT72). The drain of the PMOS transistor PT73-1 (PT74-1) is coupled to a signal line for the output signal Vox1 (Vo1). The control signal SC3 is input to the gate of the PMOS transistor PT73-2 (PT74-2). The source of the PMOS transistor PT73-2 (PT74-2) is coupled to the drain of the PMOS transistor PT71 (PT72). The drain of the PMOS transistor PT73-2 (PT74-2) is coupled to a signal line for the output signal Vox2 (Vo2). The control signal SC0 is input to the gate of the PMOS transistor PT73-3 (PT74-3). The source of the PMOS transistor PT73-3 (9T74-3) is coupled to the drain of the PMOS transistor PT71 (PT72). The drain of the PMOS transistor PT73-3 (PT74-3) is coupled to a signal line for the output signal Vox3 (Vo3).

An input transistor to which the input signals Vi and Vix are input is commonly used by a plurality of unit circuits, thereby reducing the circuit size and the drive load.

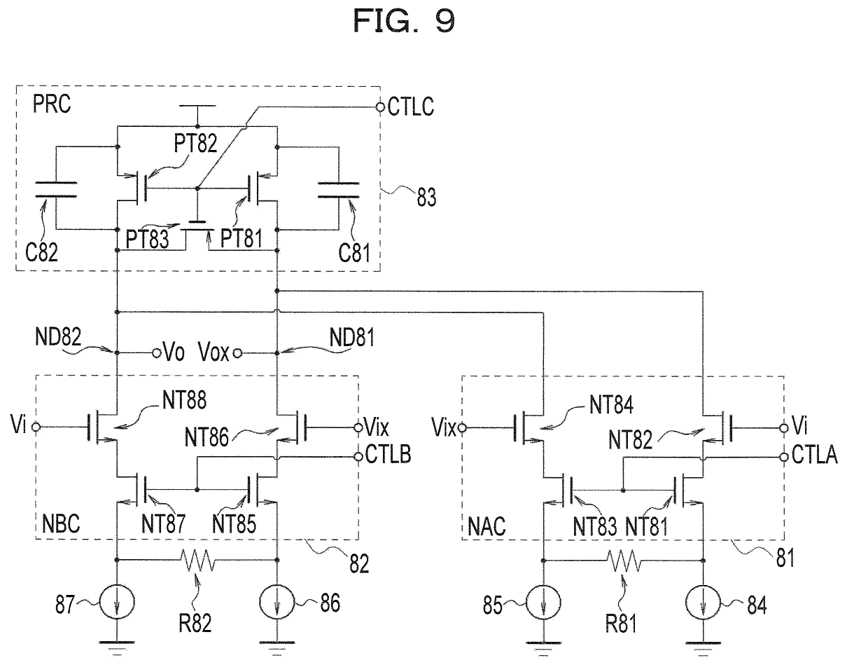

FIG. 9 illustrates an exemplary equalizer circuit. FIG. 9 may illustrate a part equivalent to a unit circuit.

Reference numeral 81 denotes a first circuit (NAC) that discharges a capacitive load through a current (charge) according to an input voltage signal. Reference numeral 82 denotes a second circuit (NBC) that charges a capacitive load through a current (charge) according to an input voltage signal. Reference numeral 83 denotes a reset circuit (PRC) that resets a capacitive load.

The first circuit (NAC) 81 includes NMOS transistors NT81, NT82, NT83, and NT84. The gate of the NMOS transistor NT81 is coupled to an input terminal CTLA. The source of the NMOS transistor NT81 is coupled to a current source 84. The drain of the NMOS transistor NT81 is coupled to the source of the NMOS transistor NT82. The gate of the NMOS transistor NT82 is coupled to an input terminal Vi. The drain of the NMOS transistor NT82 is coupled to a node ND81. The gate of the NMOS transistor NT83 is coupled to the input terminal CTLA. The source of the NMOS transistor NT83 is coupled to a current source 85. The drain of the NMOS transistor NT83 is coupled to the source of the NMOS transistor NT84. The gate of the NMOS transistor NT84 is coupled to an input terminal Vix. The drain of the NMOS transistor NT84 is coupled to a node ND82. A resistance R81 is coupled between the respective sources of the NMOS transistors NT81 and NT83.

The second circuit (NBC) 82 includes NMOS transistors NT85, NT86, NT87, and NT88. The gate of the NMOS transistor NT85 is coupled to an input terminal CTLB. The source of the NMOS transistor NT85 is coupled to a current source 86. The drain of the NMOS transistor NT85 is coupled to the source of the NMOS transistor NT86. The gate of the NMOS transistor NT86 is coupled to an input terminal Vix. The drain of the NMOS transistor NT86 is coupled to the node ND81. The gate of the NMOS transistor NT87 is coupled to the input terminal CTLB. The source of the NMOS transistor NT87 is coupled to a current source 87. The drain of the NMOS transistor NT87 is coupled to the source of the NMOS transistor NT88. The gate of the NMOS transistor NT88 is coupled to an input terminal Vi. The drain of the NMOS transistor NT88 is coupled to the node ND82. A resistance R82 is coupled between the source of the NMOS transistor NT85 and the source of the NMOS transistor NT87.

The reset circuit (PRO) 83 includes capacitive loads C81 and C82 and PMOS transistors PT81, PT82, and PT83. One end of the capacitive load C81 is coupled to the node ND81. The other end of the capacitive load C81 is coupled to a power source potential. One end of the capacitive load C82 is coupled to the node ND82. The other end of the capacitive load C82 is coupled to the power source potential. The gate of the PMOS transistor PT81 is coupled to an input terminal CTLC. The source of the PMOS transistor PT81 is coupled to the power source potential. The drain of the PMOS transistor PT81 is coupled to the one end of the capacitive load C81. The gate of the PMOS transistor PT82 is coupled to the input terminal CTLC. The source of the PMOS transistor PT82 is coupled to the power source potential. The drain of the PMOS transistor PT82 is coupled to the one end of the capacitive load C82. The gate of the PMOS transistor PT83 is coupled to the input terminal CTLC. The source of the PMOS transistor PT83 is coupled to the one end of the capacitive load C81. The drain of the PMOS transistor PT83 is coupled to the one end of the capacitive load C82.

An output terminal Vo is coupled to the node ND82. An output terminal Vox is coupled to the node ND81.

One of the control signals SC0, SC1, SC2, and SC3 is input to the input terminal CTLA of the first circuit (NAC), the input terminal CTLB of the second circuit (NBC), and the input terminal CTLC of the reset circuit (PRC). The control signals input to the input terminals CTLA, CTLB, and CTLC may be different from each other. For example, when the control signal SC0 is input to the input terminal CTLA, the control signal SC1 may be input to the input terminal CTLB, and the control signal SC3 may be input to the input terminal CTLC. A differential input signal input to the equalizer circuit, for example an in-phase signal Vi, is input to the input terminal Vi of the first circuit (NAC) and the input terminal Vi of the second circuit (NBC). A differential input signal input to the equalizer circuit, for example an opposite-phase signal Vix, is input to the input terminal Vix of the first circuit (NAC) and the input terminal Vix of the second circuit (NBC).

A circuit including the NMOS transistors NT82 and NT84, the current sources 84 and 85, and the resistance R81 may correspond to the transconductor 11 illustrated in FIG. 2. A circuit including the NMOS transistors NT81 and NT83 may correspond to the switch SWAj illustrated in FIG. 2. A circuit including the NMOS transistors NT86 and NT88, the current sources 86 and 87, and the resistance R82 may correspond to the transconductor 12 illustrated in FIG. 2. A circuit including the NMOS transistors NT85 and NT87 may correspond to the switch SWBj illustrated in FIG. 2. A circuit including the PMOS transistors PT81, PT82, and PT83 may correspond to the switch SWCj illustrated in FIG. 2. The capacitive loads C81 and C82 may correspond to the capacitive load Cj illustrated in FIG. 2. The first circuit (NAC) 81 charges the capacitive loads C81 and C82 a current (charge) according to input signals Vix and Vi, which are in opposite phase to input signals Vi and Vix which the second circuit (NBC) 82 uses for charging the capacitive loads C81 and C82. Since the capacitive loads C81 and C82 are charged based on a current (charge) according to the input signals Vix and Vi in the opposite phase, the first circuit (NAC) 81 discharges the capacitive loads C81 and C82 through a current (charge) according to the input signals Vix and Vi from the capacitive loads C81 and C82.

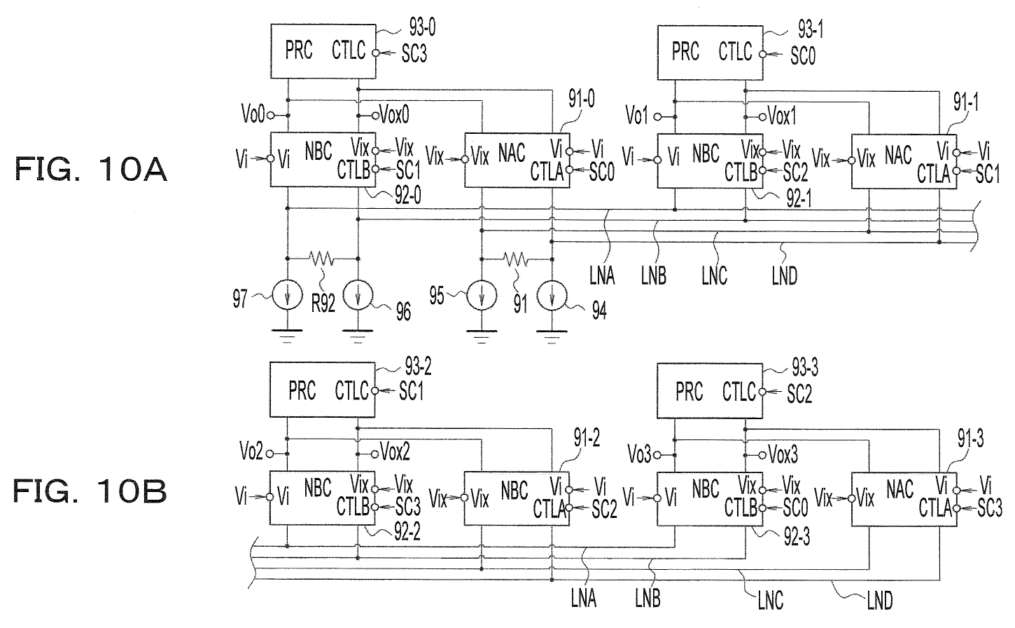

FIGS. 10A and 10B illustrate an exemplary equalizer circuit. Reference numerals 91-0, 91-1, 91-2, and 91-3 each denote a first circuit (NAC) that discharges a capacitive load through a current (charge) according to an input signal from a capacitive load, which may be substantially the same as or similar to the first circuit (NAC) 81 illustrated in FIG. 9. Reference numerals 92-0, 92-1, 92-2, and 92-3 each denote a second circuit (NBC) that charges a capacitive load based on a current (charge) according to an input signal, which may be substantially the same as or similar to the second circuit (NBC) 82 illustrated in FIG. 9. Reference numerals 93-0, 93-1, 93-2, and 93-3 each denote a reset circuit (PRC) that resets a charge in a capacitive load, which may be substantially the same as or similar to the reset circuit (PRC) 83 illustrated in FIG. 9.

The differential input signal Vi input to the equalizer circuit is input to the respective input terminals Vi of the first circuits (NAC) 91-0, 91-1, 91-2, and 91-3 and the second circuits (NBC) 92-0, 92-1, 92-2, and 92-3. The differential input signal Vix input to the equalizer circuit is input to the respective input terminals Vix of the first circuits (NAC) 91-0, 91-1, 91-2, and 91-3 and the second circuits (NBC) 92-0, 92-1, 92-2, and 92-3.

A unit circuit includes the first circuit (NAC) 91-0, the second circuit (NBC) 92-0, the reset circuit (PRC) 93-0, current sources 94, 95, 96, and 97, and resistances R91 and R92, and outputs output signals Vo0 and Vox0. The control signal SC0 is input to the input terminal CTLA of the first circuit (NAC) 91-0. The control signal SC1 is input to the input terminal CTLB of the second circuit (NBC) 92-0. The control signal SC3 is input to the input terminal CTLC of the reset circuit (PRC) 93-0.

A unit circuit includes the first circuit (NAC) 91-1, the second circuit (NBC) 92-1, the reset circuit (PRC) 93-1, the current sources 94, 95, 96, and 97, and the resistances R91 and R92, and outputs output signals Vo1 and Vox1. The control signal SC1 is input to the input terminal CTLA of the first circuit (NAC) 91-1. The control signal SC2 is input to the input terminal CTLB of the second circuit (NBC) 92-1. The control signal SC0 is input to the input terminal CTLC of the reset circuit (PRC) 93-1.

A unit circuit includes the first circuit (NAC) 91-2, the second circuit (NBC) 92-2, the reset circuit (PRC) 93-2, the current sources 94, 95, 96, and 97, and the resistances R91 and R92, and outputs output signals Vo2 and Vox2. The control signal SC2 is input to the input terminal CTLA of the first circuit (NAC) 91-2. The control signal SC3 is input to the input terminal CTLB of the second circuit (NBC) 92-2. The control signal SC1 is input to the input terminal CTLC of the reset circuit (PRC) 93-2.

A unit circuit includes the first circuit (NAC) 91-3, the second circuit (NBC) 92-3, the reset circuit (PRC) 93-3, the current sources 94, 95, 96, and 97, and the resistances R91 and R92, and outputs output signals Vo3 and Vox3. The control signal SC3 is input to the input terminal CTLA of the first circuit (NAC) 91-3. The control signal SC0 is input to the input terminal CTLB of the second circuit (NBC) 92-3. The control signal SC2 is input to the input terminal CTLC of the reset circuit (PRC) 93-3.

The equalizer circuit illustrated in FIGS. 10A and 10B performs an equalization operation illustrated for example in FIG. 4 based on the control signals SC0, SC1, SC2, and SC3 from a multi-phase timing signal generation circuit.

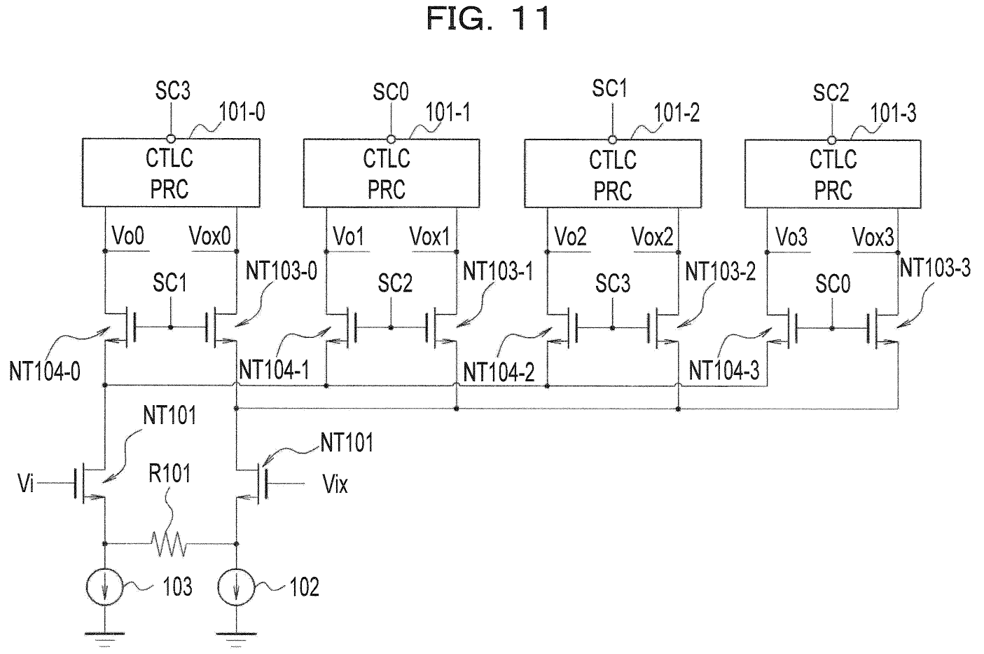

FIG. 11 illustrates an exemplary equalizer circuit. In FIG. 11, a circuit that discharges a capacitive load through a current (charge) according to an input voltage signal from a capacitive load is not illustrated.

Reference numerals 101-0, 101-1, 101-2, and 101-3 each denote a reset circuit (PRC) that resets a charge in a capacitive load. The reset circuits (PRC) illustrated in FIG. 11 may each be substantially the same as or similar to the reset circuit (PRC) 83 illustrated in FIG. 9. The control signal SC3 is input to the input terminal CTLC of the reset circuit (PRC) 101-0. The control signal SC0 is input to the input terminal CTLC of the reset circuit (PRC) 101-1. The control signal SC1 is input to the input terminal CTLC of the reset circuit (PRC) 101-2. The control signal SC2 is input to the input terminal CTLC of the reset circuit (PRC) 101-3.

The signal Vix, of the differential input signals Vi and Vix, is input to the gate of an NMOS transistor NT101. The source of the NMOS transistor NT101 is coupled to a current source 102. The signal Vi, of the differential input signals Vi and Vix, is input to the gate of an NMOS transistor NT102. The source of the NMOS transistor NT102 is coupled to a current source 103. A resistance R101 is coupled between the respective sources of the NMOS transistors NT101 and NT102.

The control signal SC1 is input to the gate of an NMOS transistor NT103-0. The source of the NMOS transistor NT103-0 is coupled to the drain of the NMOS transistor NT101. The drain of the NMOS transistor NT103-0 is coupled to a signal line for the output signal Vox0. The control signal SC1 is input to the gate of an NMOS transistor NT104-0. The source of the NMOS transistor NT104-0 is coupled to the drain of the NMOS transistor NT102. The drain of the NMOS transistor NT104-0 is coupled to a signal line for the output signal Vo0.

The control signal SC2 is input to the gate of an NMOS transistor NT103-1 (NT104-1). The source of the NMOS transistor NT103-1 (NT104-1) is coupled to the drain of the NMOS transistor NT101 (NT102). The drain of the NMOS transistor NT103-1 (NT104-1) is coupled to a signal line for the output signal Vox1 (Vo1). The control signal SC3 is input to the gate of an NMOS transistor NT103-2 (NT104-2). The source of the NMOS transistor NT103-2 (NT104-2) is coupled to the drain of the NMOS transistor NT101 (NT102). The drain of the NMOS transistor NT103-2 (NT104-2) is coupled to a signal line for the output signal Vox2 (Vo2). The control signal SC0 is input to the gate of an NMOS transistor NT103-3 (NT104-3). The source of the NMOS transistor NT103-3 (NT104-3) is coupled to the drain of the NMOS transistor NT101 (NT102). The drain of the NMOS transistor NT103-3 (NT104-3) is coupled to a signal line for the output signal Vox3 (Vo3).

As illustrated in FIG. 11, an input transistor for the input signals Vi and Vix are commonly used by a plurality of unit circuits, thereby reducing the circuit size and the drive load.

The equalizer circuit integrates a current according to the input voltage signal in different periods for each unit circuit to operate as a digital high-pass filter. The equalizer circuit generates an equalized signal subjected to an equalization process by compensating for high-frequency components attenuated through signal transmission without being affected by variations in element characteristics. The mounting area may be reduced.

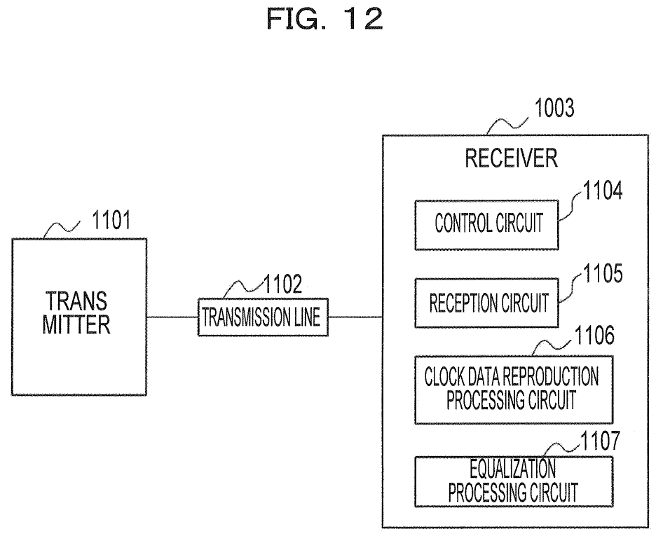

FIG. 12 illustrates an exemplary receiver. A receiver 1103 may include the equalizer circuit discussed above. Reference numeral 1101 denotes a transmitter. Reference numeral 1102 denotes a transmission line.

The receiver 1103 includes a control circuit 1104, a reception circuit 1105, a clock data reproduction processing circuit 1106, and an equalization processing circuit 1107. The control circuit 1104 controls the reception circuit 1105, the clock data reproduction processing circuit 1106, the equalization processing circuit 1107, and so forth. The reception circuit 1105 receives a signal transmitted by the transmitter 1101 via the transmission line 1102. The clock data reproduction processing circuit 1106 reproduces clock data based on the signal received by the reception circuit 1105. The equalization processing circuit 1107 includes the equalizer circuit, and compensates for attenuated high-frequency components in the received signal using a high-pass filter that provides characteristics opposite to the characteristics of the transmission line 1102.

For example, operations of discharge, charge, discharge, charge hold, and charge reset for a capacitive load may be repeated. For example, operations of discharge, charge, discharge, charge, charge hold, and charge reset for a capacitive load may be repeated. Complicated filter characteristics may be achieved by increasing the number of discharges and charges performed in accordance with a control signal for one of N phases.

Example embodiments of the present invention have now been described in accordance with the above advantages. It will be appreciated that these examples are merely illustrative of the invention. Many variations and modifications will be apparent to those skilled in the art.

1. An equalizer circuit comprising:
a plurality of amplifiers that convert a voltage signal into a current;
a plurality of capacitive loads that are charged and discharged in accordance with respective outputs of the plurality of amplifiers;
a charge discharge circuit provided for each of the plurality of capacitive loads to charge or discharge one of the plurality of capacitive loads; and
a reset circuit provided for each of the capacitive loads to initialize the charge stored in the one of the plurality of capacitive loads,
wherein a current according to the voltage signal is integrated in different periods for each of the plurality of capacitive loads and the capacitive load is discharged through the current in a first period and the capacitive load is charged through the current in a second period following the first period.

2. The equalizer circuit according to claim 1,
wherein the charge discharge circuit includes:
a first circuit that discharges the capacitive load through the current; and
a second circuit that charges the capacitive load through the current.

3. The equalizer circuit according to claim 1,
wherein a first operation, a second operation and a third operation are repeated for each of the plurality of capacitive loads, the capacitive load is charged or discharged through the current in the first operation, the charge stored in the capacitive load by the first operation is held in the second operation, and the charge stored in the capacitive load is initialized in the third operation.

4. The equalizer circuit according to claim 3,
wherein the first operation, the second operation, and the third operation are executed based on a plurality of control signals activated in different periods.

5. The equalizer circuit according to claim 4, further comprising,
a signal generation circuit that generates the plurality of control signals based on a plurality of oscillation signals which have different phases from each other.

6. The equalizer circuit according to claim 2,
wherein each of the first circuit and the second circuit includes a switch coupled between the amplifier and the capacitive load, and
the switch of the first circuit and the switch of the second circuit are controlled based on different control signals.

7. The equalizer circuit according to claim 6,
wherein the switch includes a transistor, a source and a drain of which are respectively coupled to the amplifier and the capacitive load and a gate of which is supplied with the control signal.

8. The equalizer circuit according to claim 2,
wherein the first circuit is coupled between a first amplifier included in the plurality of amplifiers which has a negative gain and the capacitive load, and
the second circuit is coupled between a second amplifier included in the plurality of amplifiers which has a positive gain and the capacitive load.

9. The equalizer circuit according to claim 2,
wherein the voltage signal includes a differential signal,
wherein the first circuit is coupled between a first amplifier included in the plurality of amplifiers to which an opposite-phase signal of the differential signal is input and the capacitive load, and
wherein the second circuit is coupled between a second amplifier included in the plurality of amplifiers to which an in-phase signal of the differential signal is input and the capacitive load.

10. The equalizer circuit according to claim 2,
wherein the control signal includes a first control signal, a second control signal, a third control signal, and a fourth control signal,
wherein the capacitive load is discharged through the current based on the first control signal,
wherein the capacitive load is charged through the current based on the second control signal,
wherein the charge stored in the capacitive load is held based on the third control signal, and
wherein the charge stored in the capacitive load is initialized based on the fourth control signal.

11. A reception apparatus comprising:
a reception circuit that receives a signal transmitted via a transmission path; and
an equalizer circuit that compensates for deterioration of the signal,
the equalizer circuit includes:
a plurality of amplifiers that convert a voltage signal into a current;
a plurality of capacitive loads that are charged and discharged in accordance with respective outputs of the plurality of amplifiers;
a charge discharge circuit provided for each of the plurality of capacitive loads to charge or discharge one of the plurality of capacitive loads; and
a reset circuit provided for each of the capacitive loads to initialize the charge stored the one of the plurality of capacitive loads,
wherein a current according to the voltage signal is integrated in different periods for each of the plurality of capacitive loads and the capacitive load is discharge through the current in a first period and the capacitive load is discharged through the current in a second period following the first period.
